(19) United States
(12) Patent Application Publication
(10) Pub. No.: US 2007/0241982 A1
(43) Pub. Date: Oct. 18, 2007

(54) Contoured triangular dipole antenna

(76) Inventors: Alan Stigliani, Hopewell Junction, NY (US); Daniel H. Schaubert, Amherst, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/230,936

(22) Filed: Sep. 20, 2005

Related U.S. Application Data
(60) Provisional application No. 60/614,865, filed on Sep. 30, 2004.

(51) Int. Cl. H01Q 9/28; H01Q 1/38

(52) U.S. Cl. 343/795; 343/700 MS; 343/846

(57) ABSTRACT

The present invention relates to a contoured dipole antenna. The antenna is suitable for ultra wide band (UWB) radio communications, and in particular UWB applications requiring antennas of small size. Elements of the dipole antenna have a curvature designed to make the antenna UWB over a desired range. Embodiments of the antenna may take the form of balanced dipole arrangements, unbalanced half-dipole arrangements, geometric arrays, and arrays distributed over a contour. In addition, embodiments of the invention may be used with or without ground planes.

### CROSS REFERENCE TO RELATED APPLICATIONS

This application claims priority under 35 U.S.C. §119(e) of U.S. Provisional Patent Application No. 60/614,865 filed on Sep. 30, 2004, the disclosure of which is hereby incorporated by reference herein.

### STATEMENT REGARDING FEDERALLY SPONSORED RESEARCH OR DEVELOPMENT

This invention was supported, in whole or in part, by a grant 5-21014 from the Department of Defense (DOD). The Government has certain rights in the invention.

### BACKGROUND OF THE INVENTION

Radio transmissions have historically been approached from a stand point of frequency content. In the frequency content context, coexistent and different radio transmissions are accomplished by assigning permissible frequencies or frequency channels to different users and radio systems. Proper operation of such a scheme requires that users operate only within their assigned allocation, especially in geographic areas having numerous users. In some instances, frequency allocations may be made based on the application of the radio signal. For example, a first group of frequencies may be assigned for person-to-person voice communications (e.g., cellular telephones, 2-way radios, etc.), a second group of frequencies may be assigned for telemetry applications (e.g., data transmission) and a third group of frequencies may be allocated for remote sensing applications (e.g., global positioning system (GPS), radio-ranging, etc.). With the advent of new communication and telemetry technologies, crowding of the frequency spectra assigned to users has become an issue. As a result, alternative means of wireless communication are beginning to become available.

Ultra wide band (UWB) transmission is one such alternative means of wireless radio frequency (RF) transmission. UWB transmissions, also referred to as impulse radio, differ from conventional radio transmissions in that UWB transmissions exist over a wide range of frequencies simultaneously. UWB can employ very short duration radio pulses having tightly controlled amplitude and pulse-to-pulse intervals. Since UWB transmissions use short pulses, typically less than a nanosecond, UWB antennas must be broadband for optimal operation. Conventional RF antennas tend to perform inadequately in UWB environments, since they tend to disperse and alter the amplitude of the spectral, or frequency, components of the signal resulting in broadening of the short pulses utilized in UWB systems. Thus, there is a need for further improvements in antennas for RF transmission.

### BRIEF SUMMARY OF THE INVENTION

The system and method of the present invention includes an antenna having a substantially planar surface with contoured boundaries comprising a generally near triangular shape. The shape of the antenna can generally be described as having a vertex or tip at a first end along a longitudinal axis that bisects the antenna and a base at the second end that is wider than the vertex. The planar surface also has first and second curved sides that are symmetric about the. longitudinal axis. The sides are non-linear and can be concave, convex, or a combination thereof. The shape of the antenna element serves to enhance the radiating and reception patterns of the device.

A preferred embodiment uses a first antenna element paired with a second matching antenna element, preferably aligned along a common axis in a single plane and meeting at a location such as the intersection of the respective vertices of the two antennas to provide a balanced dipole antenna. This balanced antenna is symmetric about both the longitudinal axis and a lateral axis that bisects the two elements. Standard terminals and antenna connections can be used to couple the antenna to the receiver and/or transmitter electronics.

In another preferred embodiment, one or more antenna elements can be positioned relative to a different surface such as a planar surface. In this embodiment, the tip or distal end of the antenna element, or antenna elements, can be oriented toward the planar surface. The longitudinal axis of each antenna element preferably extends orthogonally from the planar surface. In an embodiment employing a plurality of antennas, the antennas can be oriented parallel to each other or at different angles on one side of the planar surface. The plurality of antennas can be arranged in an evenly distributed geometric pattern or along one or more contour lines. The antenna configuration will depend on the particular transmission and/or reception pattern optimized for a particular application.

The present invention is particularly well suited for UWB applications with frequencies in a range of 2.5 GHz to more than 12 GHz. Preferred embodiments of the present invention can be used for transmission and/or reception of wireless signals in a variety of applications.

In addition, UWB antennas of the invention have small form factors for facilitating usage in remote sensing and telemetry applications such as equipment tracking systems, smart card and reader systems, and positioning systems. For example, UWB antennas having small form factors may be placed inside smart cards without adversely impacting the overall size of the card.

A preferred embodiment of the invention involves a method of using an antenna to transmit and/or receive wireless data. Transmitter electronics can be used to send data to the antenna for RF transmission to a receiver. An antenna in accordance with the invention can be used to receive the data which is then detected and proceed to provide data output signals.

### BRIEF DESCRIPTION OF THE SEVERAL VIEWS OF THE DRAWINGS

The foregoing and other objects, features and advantages of the invention will be apparent from the following more particular description of preferred embodiments of the invention as illustrated in the accompanying drawings in which like reference characters refer to the same or similar parts throughout the different views. The drawings are not necessarily to scale, emphasis instead being placed upon illustrating the principles of the invention.

FIG. 1A illustrates an exemplary embodiment of contoured dipole antenna in accordance with an aspect of the invention;

FIG. 1B illustrates a method of use of the antenna in accordance with a preferred embodiment of the invention;

FIGS. 2A-D illustrate exemplary impedance performance (2A-2B) and exemplary voltage transfer functions (2C-2D) graphs associated with the embodiment of FIG. 1A;

FIGS. 3A-K illustrate exemplary E-plane patterns for an antenna having the form of the embodiment shown in FIG. 1A;

FIGS. 4A-K illustrate exemplary H-plane patterns for an antenna having the form of the embodiment shown in FIG. 1A;

FIG. 5 illustrates an exemplary embodiment of the invention utilizing a single half-dipole antenna and a ground plane;

FIG. 6 illustrates an exemplary embodiment of the invention utilizing a plurality of half-dipole antennas arranged in a geometric pattern on a ground plane;

FIG. 7 illustrates an exemplary embodiment of the invention utilizing a plurality of half-dipole antennas arranged along a contour on a ground plane; and

FIGS. 8A-C illustrate preferred embodiments of the invention.

### DETAILED DESCRIPTION OF THE INVENTION

The following detailed description of the invention refers to the accompanying drawings. Reference will be made in detail to exemplary embodiments of the present invention, examples of which are illustrated in the accompanying drawings. While exemplary embodiments are provided, other embodiments are possible in light of the specification. Therefore, unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged and/or rearranged without departing from the disclosed systems and methods. Additionally, the shapes and sizes of components are also exemplary.

Before describing the invention, it is noted that exemplary coordinate systems may be used when describing embodiments of the invention. Coordinate systems, as used herein, are merely aids for describing relationships among elements of the invention. As such, coordinate systems should not be construed as limitations or essential features of the invention.

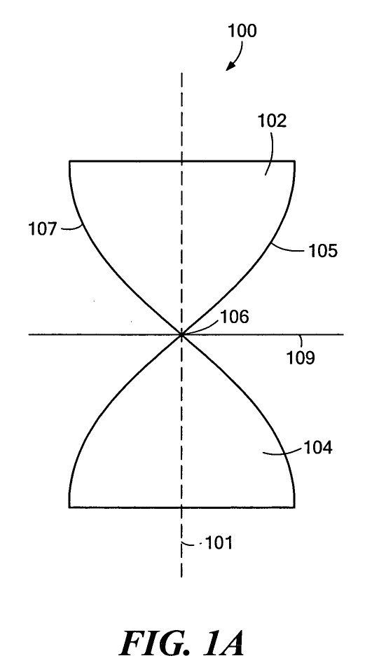

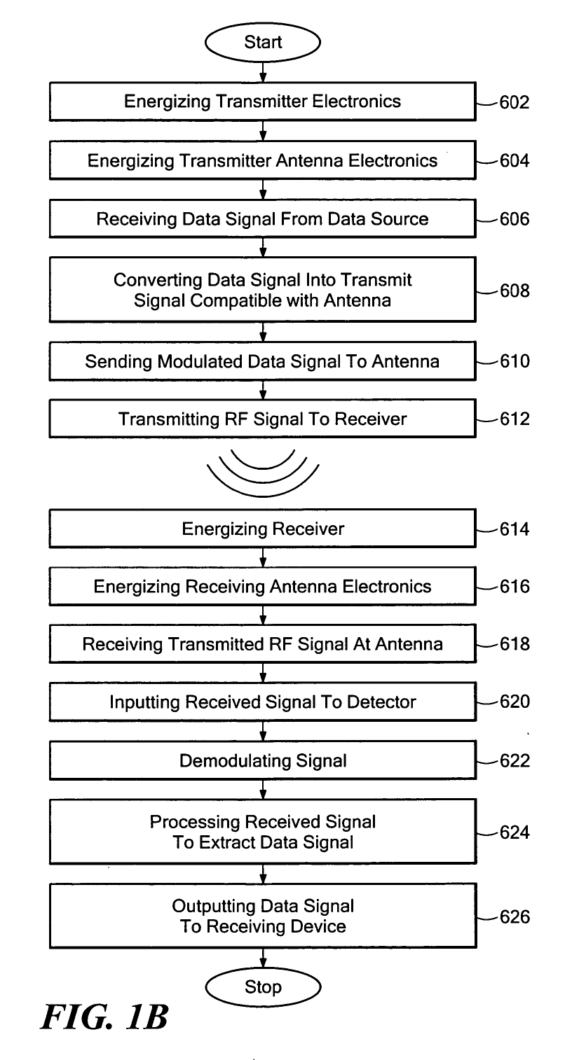

FIG. 1A illustrates an exemplary embodiment of a dipole antenna 100 consistent with aspects of the invention. Antenna 100 comprises opposedly mounted ends which have essentially similar shapes, composition and size. In particular, antenna 100 comprises a first antenna element 102, a second antenna element 104, and a common junction, or vertex, 106. The junction can also be described as the intersection of the longitudinal axis 101 and the lateral axis 109 that are orthogonal to each other and define axes of symmetry of the device. In the embodiment of FIG. 1A, the first and second elements are generally triangular in shape. Furthermore, the first element 102 and second element 104 elements are contoured in that they have respective curvatures designed to enhance performance as a UWB radiator and/or receiver. In particular, an example of the embodiment of FIG. 1A may be described using a mathematical equation. Each element has sides 105, 107 that have a curved shape.

In a coordinate system oriented such that the origin is located at the center of the antenna and the x-axis is oriented along the longitudinal axis of the dipole, the curvature of the antenna in the first quadrant of the coordinate axes may be described, or substantially described, using the piecewise definition of equations 1 and 2 where x and y are in identical units.
y=x, for 0<x≦;4.2 (1)
y=1.25x^{0.85}, for 4.2<x<15 (2)
The equations produce curvatures that increase with distance from the center of the antenna.

The antenna 100 can comprise electrically conductive material such as a metal, a composite material, or a non-conductive or semi-conductive material impregnated with conductive particles. In addition, the antenna 100 may be formed to a desired shape by machining, stamping, injection molding, using pressure such as forging, or by heat.

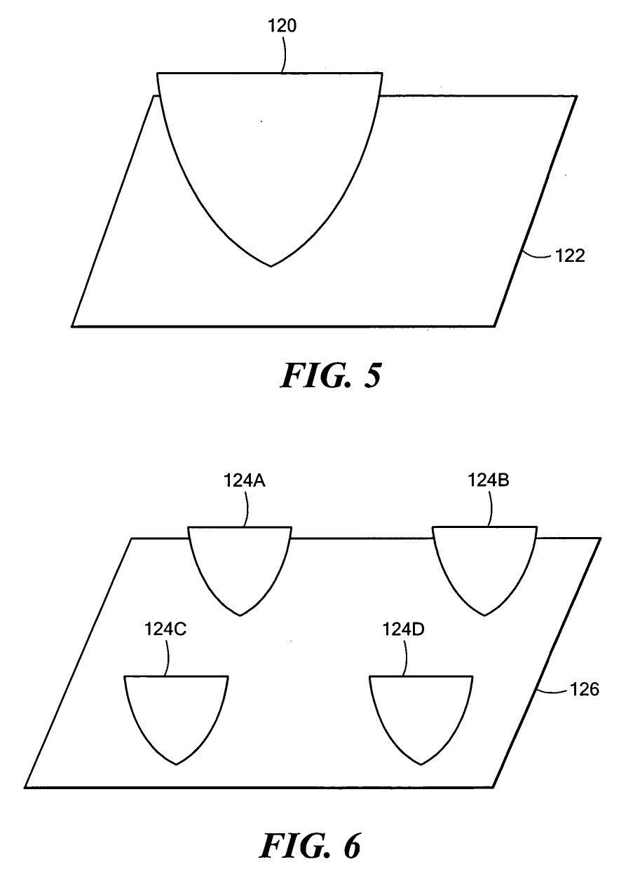

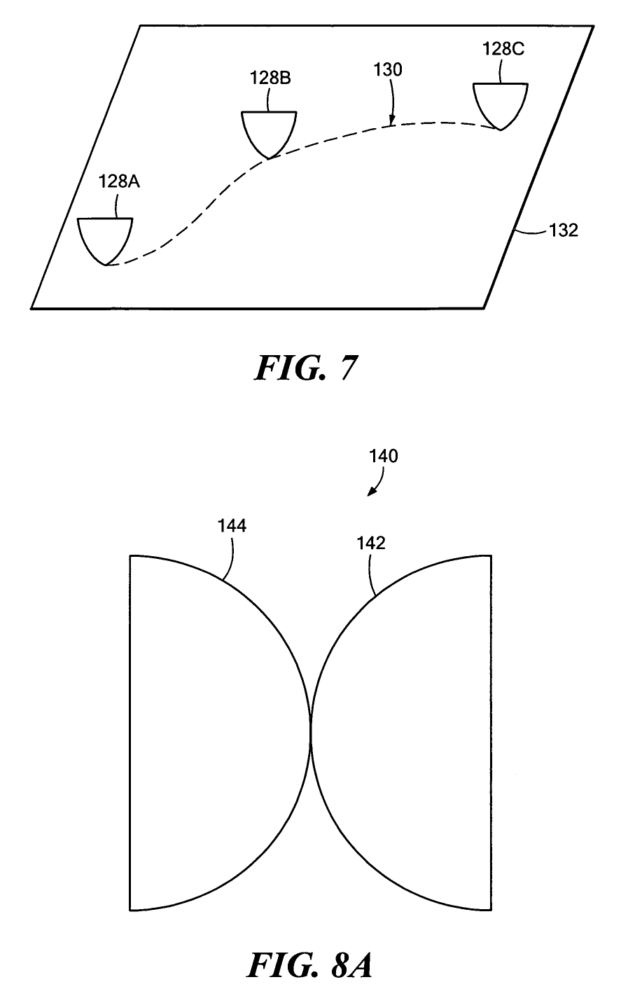

FIG. 1B illustrates an exemplary method for facilitating communication between a transmitter and a receiver using embodiments of the invention. The method begins by energizing the transmitter electronics (per step 602) and the transmitting antenna Electronics (per step 604). The transmitting antenna may be comprised of a dipole antenna such as shown in FIG. 1A, a half dipole antenna such as shown in FIG. 5, a plurality of half dipole antennas such as shown in FIGS. 6 and 7, or a plurality of balanced dipole antennas. A data signal is received from a source such as a computer, microphone, sensor, etc. (per step 606). The data signal is then converted into a transmit signal compatible with the transmitting antenna (per step 608). Conversion of the data signal into a signal compatible with the transmitting antenna may include modulating the data signal. The modulated data signal is then conveyed to the transmitting antenna (per step 610). The modulated data signal is conveyed through a transmission medium such as air, water, building structure, free space, etc. as an RF signal (per step 612).

A receiver is energized at a time prior to receipt of the transmitted data signal (per step 614). In addition, the receive antenna electronics are energized (per step 616). In alternative embodiments, receiver electronics and receive antenna electronics may not be energized until the receive antenna senses a signal. In such an alternative embodiment, the receive antenna may employ an energy threshold that serves as a trigger when received energy exceeds a predetermined threshold either instantaneously or over some time-averaged period.

The RF data signal is received at the receiver antenna (per step 618). In alternative embodiments, a plurality of receive antennas may be employed as a receive array. In such an embodiment, data received at the antennas may be delayed by predetermined time intervals such that a main receiving lobe is steered in a desired direction. The received signal is conveyed from the receive antenna to a signal detector (per step 620). The received signal is then demodulated (per step 622) and processed to extract the data signal received from the source (per step 624). The data signal is then outputted to a receiving device (per step 626).

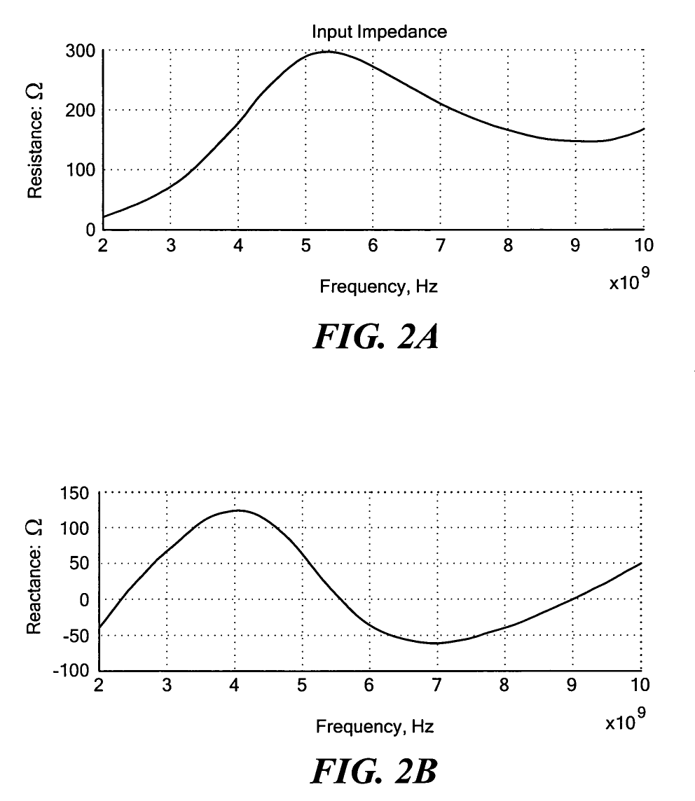

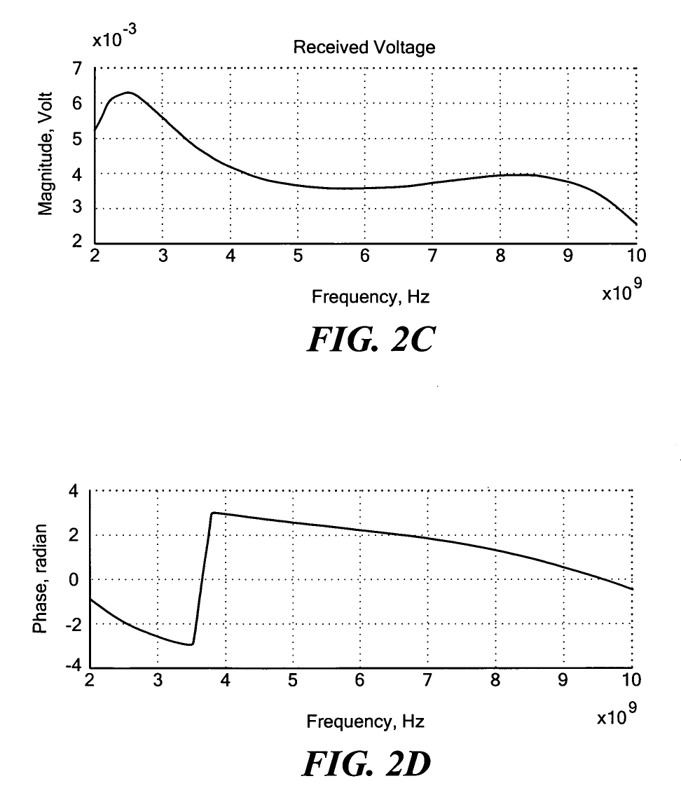

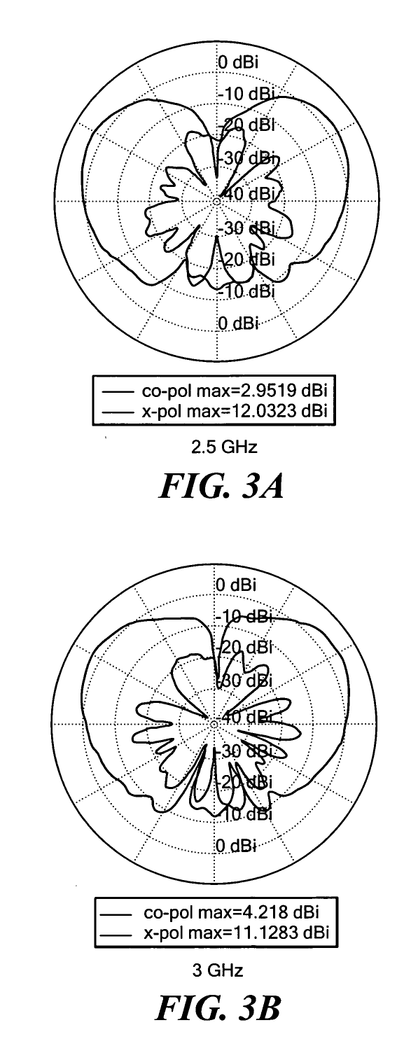

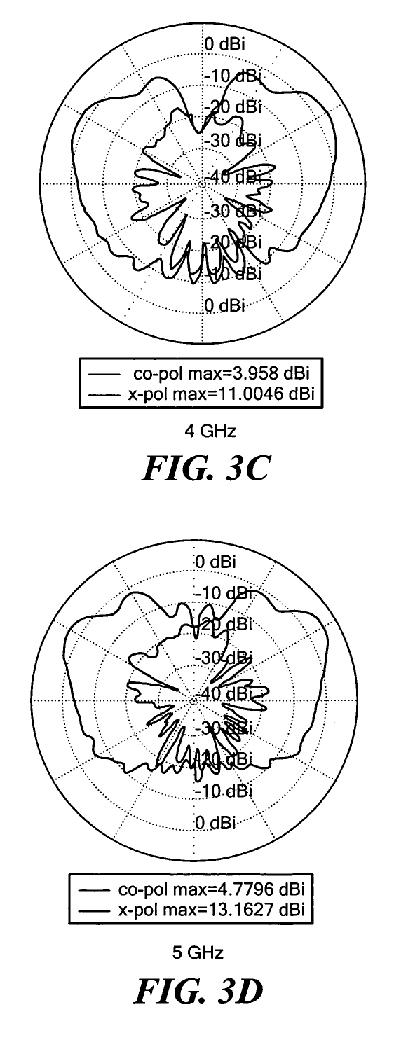

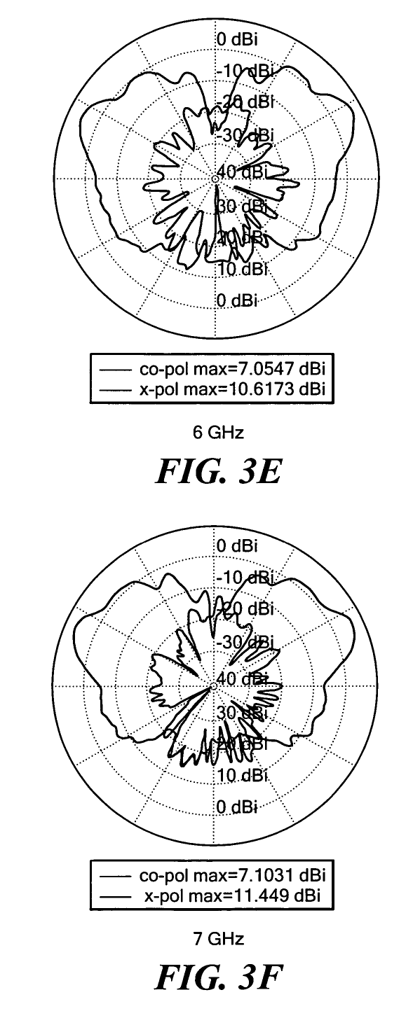

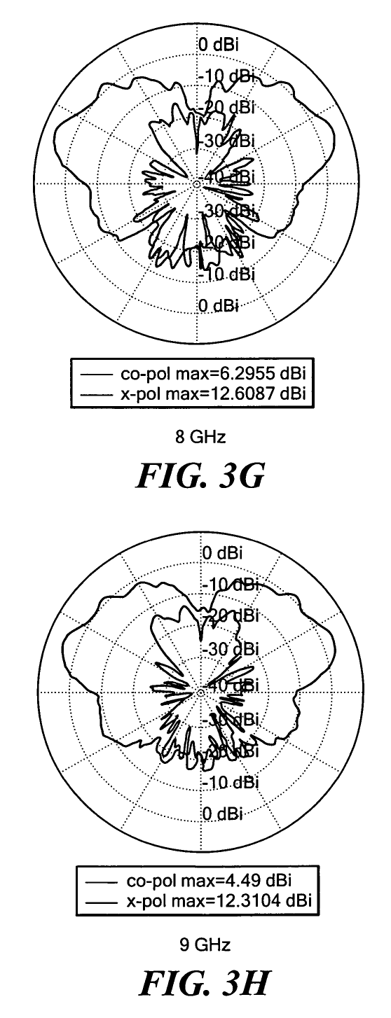

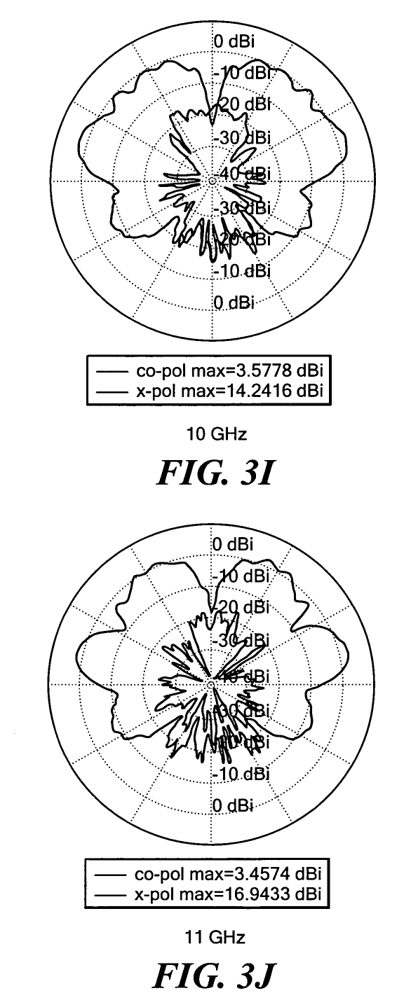

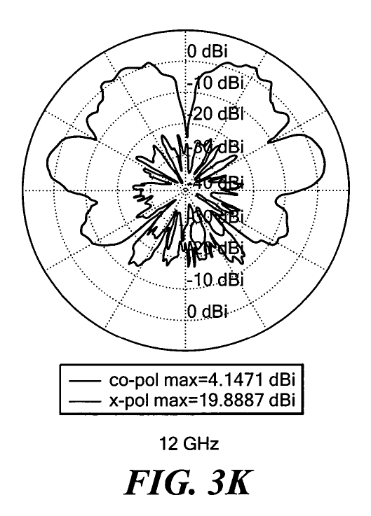

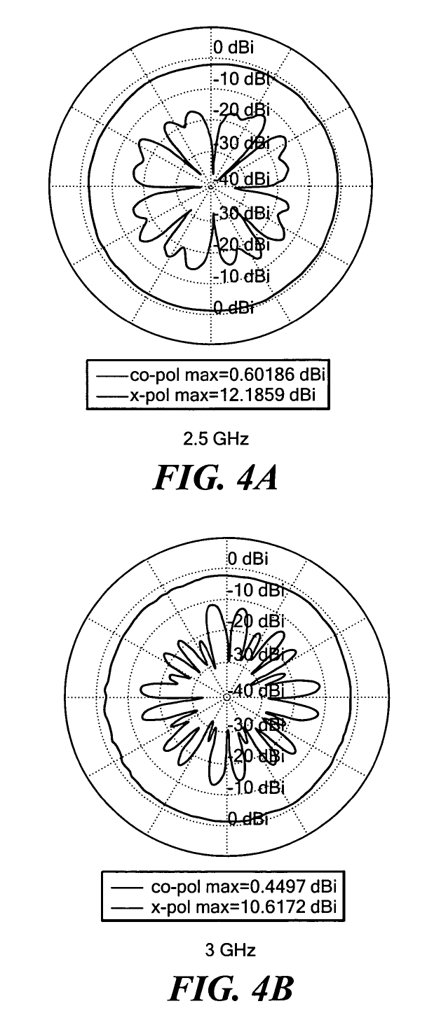

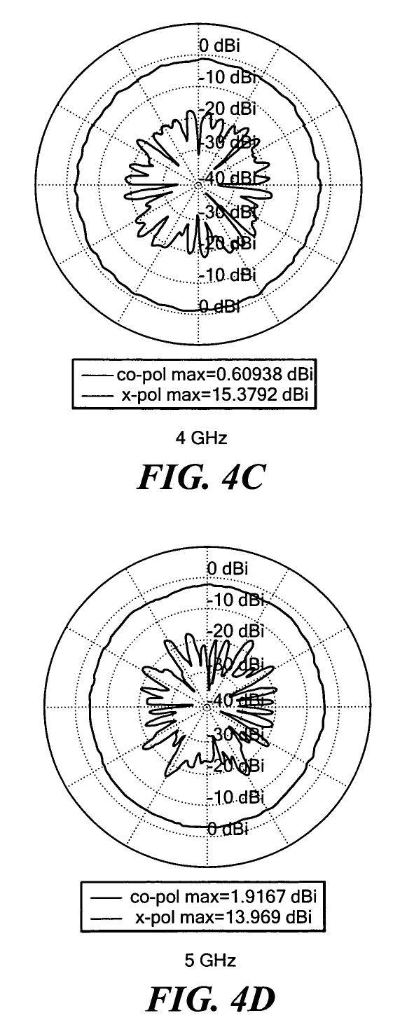

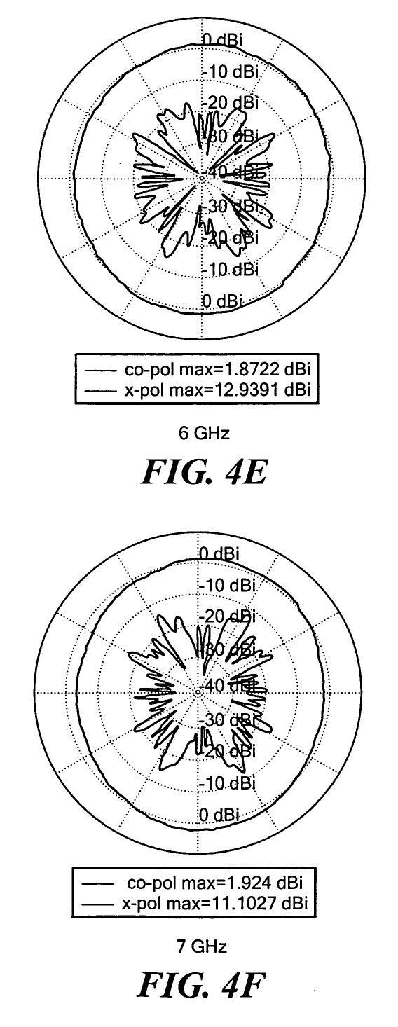

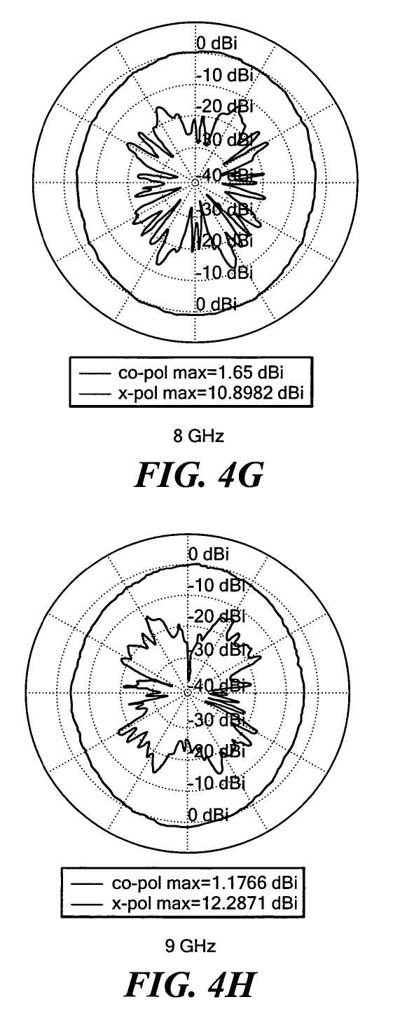

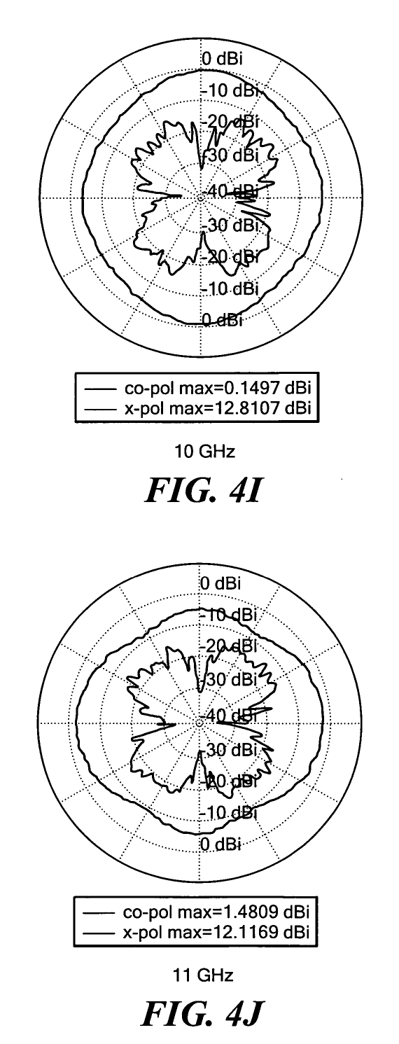

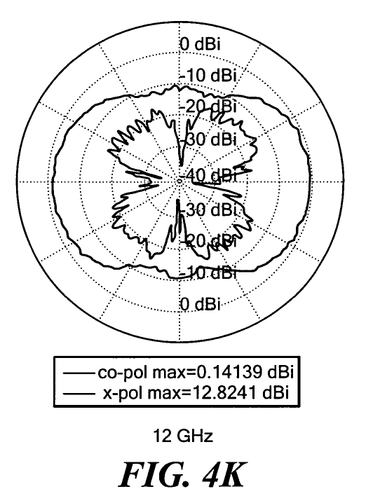

A graph of the calculated impedance performance of antenna 100 is illustrated in FIGS. 2A and 2B, and the calculated voltage transfer function of a communication link comprising two antennas 100 is shown in FIGS. 2C and 2D. Graphs showing measured radiation patterns for the E and H radiating planes of antenna 100 are shown in FIGS. 3A3K (E-plane) and FIGS. 4A-K (H-plane) for frequencies ranging from 2.5 GHz to 12 GHz.

The antenna of FIG. 1A is designed to be balanced so that it radiates effectively in the full spherical region of space with a radiation pattern producing directive gain in the vicinity of the plane bisecting the conductors of antenna 100. The curvature imparted to elements of antenna 100 produces performance improvements when compared to prior art bow-tie antennas. The contoured antenna of FIG. 1A also provides operation over a wider useful bandwidth without having to employ log-periodic or fractal geometric antennas, since both types require larger antennas. In addition, the antenna of FIG. 1A does not disperse the spectral components of received signals. Signal dispersion in a UWB application may cause undesirable pulse distortion. The antenna of FIG. 1A further operates in an omnidirectional manner making it useful in applications where the location of a transmitter/receiver is a priori unknown with respect to antenna 100.

The antenna 100 may also be fabricated making it useful for remote sensing applications such as secure-ID cards, asset tracking using flat label-like radio frequency identification (RFID) tags, keyless access cards, smart cards, and other applications requiring UWB antennas having a small foot print. For example, the antennas can have a size of 1-2 centimeters or less in both length and width.

The antenna 100 is also useful in wireless fidelity (Wi-Fi) applications such as IEEE 802.116 and Bluetooth. In addition, antenna 100 can operate in the gigahertz range making it useful for high speed data communications in handheld low power devices such as wireless digital communications, for example, a wireless USB connection, and for position tracking applications.

FIG. 5 illustrates an embodiment of a half dipole antenna 120 incorporating a ground plane 122 at the line of symmetry of the balanced antenna 100 of FIG. 1A. The antenna 120 is unbalanced and radiates effectively in the hemispherical region of space above ground plane 122. In addition, the radiation pattern of antenna 120 produces directive gain in and around the plane of ground plane 122.

FIG. 6 illustrates an embodiment of the invention incorporating a plurality of substantially flat half dipole antennas. In FIG. 6, four antennas 124A, B, C, Dare disposed in a two row by two column geometric layout on a ground plane 126. Arrays using larger numbers of rows and columns can also be used. The geometry of FIG. 6 acts as an array of elements operating in an unbalanced configuration. This configuration effectively radiates in the upper hemispherical region of space with a radiation pattern producing directive gain in and around the plane of conducting ground plane 126. In addition, each antenna of FIG. 6 may be driven with a different signal so as to change the directional properties of the antennas and producing a beamformed output signal.

FIG. 7 illustrates an exemplary embodiment of the invention having a plurality of antennas 128A, B, C disposed along ground plane 132 in a manner following a predefined contour 130. Antennas 128A, 128B and 128C disposed along contour 130 may be coupled so as to operate as an array of elements or may be operated independently. The embodiment of FIG. 7 is unbalanced and it radiates effectively in the hemispherical region above ground plane 132. In addition, the arrangement of FIG. 7 produces a radiation pattern producing directive gain in and around the plane of ground plane 132.

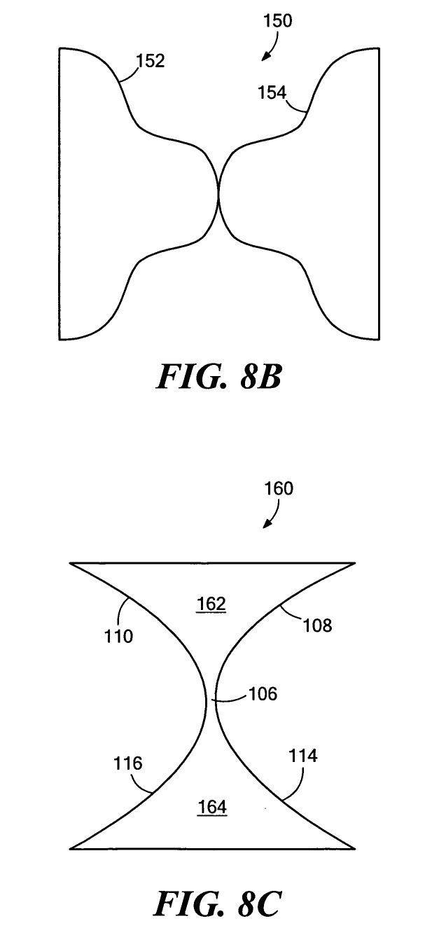

FIGS. 8A-C illustrate alternate designs of three embodiments of a balanced antenna configuration such as that shown in FIG. 1A. In addition, the curvatures may be designed using computer models, curve fitting analyses tools and/or by experimentation.

FIG. 8A illustrates an antenna 140 having curvatures that decrease with distance away from the origin. The sides 142, 144 have a convex curvature. FIG. 8B illustrates an antenna 150 having a curvature that varies, i.e. increases and decreases, with distance away from the origin. The sides 152, 154 have a curvature that has a convex portion and a concave portion. FIG. 8C illustrates another preferred embodiment of an antenna 160 having a first end 162 and a second end 164 which meet at an intersection 106. The sides 108, 110, 114, 116 of the first and second sections or ends 162, 164, respectively, are concave. Thus, the sides of the planar antenna elements are generally non-linear or curved to enhance the radiating pattern.

Many changes in the details, materials and arrangements of parts, herein described and illustrated, can be made by those skilled in the art in light of teachings contained hereinabove. Accordingly, it will be understood that the following claims are not to be limited to the embodiments disclosed herein and can include practices other than those specifically described, and are to be interpreted as broadly as allowed under the law.

What is claimed is:

1. A radio frequency communications antenna comprising:
a contoured signaling surface that is symmetric about a longitudinal axis and includes an electrically conductive material, the contoured surface having a first end and a base at a second end, the contoured surface having a first curved side and a second curved side.

2. The communications antenna of claim 1 wherein said antenna transmits ultra wide band communications signals.

3. The communications antenna of claim 1 wherein said antenna receives ultra wide band communications signals.

4. The communications antenna of claim 2 wherein said contoured signaling surface is communicatively coupled to a transmitter.

5. The communications antenna of claim 1 wherein said contour is defined using an equation.

6. The communications antenna of claim 5 wherein the contour is defined by y=x, for 0<x≦4.2 and
y=1.25x^{o.85}, for 4.2<x<15.

7. The communications antenna of claim 5 wherein said signaling surface comprises metal.

8. The communications antenna of claim 5 wherein said first end is mounted relative to a ground plane.

9. The communications antenna of claim 5 further comprising a second contoured signaling surface having essentially the same shape, size and contour as that of said contoured signaling surface, said second contoured signaling surface being oriented with respect to said contoured signaling surface so that the first end of the respective signaling surfaces are proximate to each other while the outer edges of the respective signaling surfaces are opposed, the orientation of said signaling surfaces producing a dipole antenna.

10. The communications antenna of claim 9 wherein said dipole antenna is used for asset tracking.

11. The communications antenna of claim 9 wherein said dipole antenna is used for determining a position.

12. The communications antenna of claim 9 wherein said dipole antenna is used to communicate data.

13. The communications antenna of claim 1 further comprising a plurality of contoured signaling surfaces communicatively associated with one another or individually and disposed on a ground plane in a geometric pattern allowing said plurality to operate as an array.

14. The communications antenna of claim 1 further comprising a plurality of contoured signaling surfaces communicatively associated with each other and disposed along a ground plane according to a defined contour, said contour for facilitating cooperative operation of the plurality.

15. The communications antenna of claim 1 further comprising a wireless communications device.

16. A method of using an antenna comprising:
providing an antenna including a first antenna element that is symmetric about a longitudinal axis and having a base, a first curved side, a second curved side and a distal end in proximity to a second antenna element; and
actuating the antenna to provide a wireless connection.

17. The method of claim 16 further comprising providing a second antenna element that extends in a plane that is orthogonal to a longitudinal axis that bisects the first antenna element.

18. The method of claim 16 providing a second antenna element extending in a plane with the first antenna element.

19. The method of claim 16 further comprising transmitting wireless data with the antenna.

20. The method of claim 16 further comprising receiving wireless data with the antenna.
